(19) United States
(12) Patent Application Publication
(10) Pub. No.: US 2019/0220881 A1
(43) Pub. Date: Jul. 18, 2019

(54) SYSTEMS, METHODS AND COMPUTER READABLE MEDIA FOR CREATING AND PROCESSING A DIGITAL VOUCHER

(71) Applicant: Mastercard International Incorporated, Purchase, NY (US)

(72) Inventors: Sudhir Gupta, Pune (IN); Partho Sarothi Roy, Pune (IN); Lloyd Fernandes, Pune (IN); Rahul Agrawal, Pune (IN); Lakshmi Narasimhan Ramanujam, Chennai (IN); Krutika Eknath Gonnade, Pune (IN); Abhishek Chaturvedi, Lucknow (IN); Ketan Shrikant Joshi, Pune (IN); Gaurav K. Patni, Pune (IN)

(73) Assignee: Mastercard International Incorporated, Purchase, NY (US)

(21) Appl. No.: 16/247,924

(22) Filed: Jan. 15, 2019

(30) Foreign Application Priority Data
Jan. 17, 2018 (SG) 10201800449Q

(51) Int. Cl. G06Q 30/02; G06Q 20/36; G06Q 20/38; G06Q 20/40

(52) U.S. Cl. CPC G06Q 30/0215; G06Q 20/40145; G06Q 20/387; G06Q 20/3672

(57) ABSTRACT

The present application provides systems, methods and computer readable media for creating and processing a digital voucher. The methods comprises a method for utilising a funding account of a first user to create a digital voucher having a value for a second user, the digital voucher being usable by the second user for remitting one or more transactions across participating parties that communicate with a payment network, the method comprising: generating, at a server for creating the digital voucher, a unique code of the digital voucher upon verification of a sufficient balance in the funding account, the unique code identifying an issuer party of the funding account and a payment network provider of the payment network, wherein the unique code is associated with a unique identifier of the second user.

### CROSS REFERENCE TO RELATED APPLICATIONS

This application claims priority to Singaporean Application Serial No. 10201800449Q, filed Jan. 17, 2018, which is incorporated herein by reference in its entirety

### FIELD OF INVENTION

The following disclosure relates to systems, methods and computer readable media for creating and processing a digital voucher.

### BACKGROUND

There are people who do not own any saving accounts, credit or debit card accounts, or pre-paid payment card accounts with any financial institutions (for example, banks), which are known fundamental requirements of card transactions and card-less digital wallet transactions, such as automated teller machine (ATM) cash withdrawals, Point of Sale (POS) transactions, and/or digital payments.

Without the above accounts, monetary transactions for these people are restrained to cash transactions only, which hinder them from enjoying card transactions and card-less digital payments.

There is thus a need for a technical solution to provide systems, methods and computer readable media to address the above shortcomings, so as to enable card transactions and card-less digital payments to be enjoyed by users who do not have any saving accounts, credit or debit card accounts, or pre-paid payment card accounts with any financial institutions. Furthermore, other desirable features and characteristics will become apparent from the subsequent detailed description and the appended claims, taken in conjunction with the accompanying drawings and this background of the disclosure.

### SUMMARY

According to a first aspect of the present invention, there is provided a method for utilising a funding account of a first user to create a digital voucher having a value for a second user, the digital voucher being usable by the second user for remitting one or more transactions across participating parties that communicate with a payment network. The method comprises: generating, at a server for creating the digital voucher, a unique code of the digital voucher upon verification of a sufficient balance in the funding account, the unique code identifying an issuer party of the funding account and a payment network provider of the payment network, wherein the unique code is associated with a unique identifier of the second user.

According to a second aspect of the present invention, there is provided a method for processing a digital voucher at a server that administers a payment network, the digital voucher being created for a second user based on a funding account of a first user, the digital voucher having a value for remitting a transaction for the second user at a participating party that communicates with a payment network. The method comprises: validating the digital voucher upon verification of a unique code of the digital voucher based on a unique identifier of the second user, the unique code identifying an issuer party of the funding account and a payment network provider of the payment network; and authorising the remittance of the transaction with at least a portion of the value of the digital voucher, wherein the at least a portion of the value is deducted from a blocked fund in the funding account at a server that administers the issuer party of the funding account.

According to a third aspect of the present invention, there is provided a server that administers a payment network for utilising a funding account of a first user to create a digital voucher for a second user having a value, the digital voucher being usable by the second user for remitting one or more transactions across participating parties that communicate with a payment network. The server comprises at least one processor and at least one memory including computer program code. The at least one memory and the computer program code are configured to, with the at least one processor, cause the server at least to: generate a unique code of the digital voucher upon verification of a sufficient balance in the funding account, the unique code identifying an issuer party of the funding account and a payment network provider of the payment network, wherein the unique code is associated with a unique identifier of the second user.

According to a fourth aspect of the present invention, there is provided a server that administers a payment network for processing a digital voucher having a value for remittance of a transaction at a participating party that communicates with the payment network, the digital voucher being created for a second user based on a funding account of a first user. The server comprises: at least one processor; and at least one memory including computer program code; the at least one memory and the computer program code configured to, with the at least one processor, cause the server at least to: validate the digital voucher upon verification of a unique code of the digital voucher based on a unique identifier of the second user; and authorise the remittance of the transaction with at least a portion of the value of the digital voucher, wherein the at least a portion of the value is deducted from a blocked fund in the funding account at a server that administers an issuer party of the funding account.

According to a fifth aspect of the present invention, there is provided a computer readable medium comprising instructions which, when executed by a processor, make the processor perform a method for utilising a funding account of a first user to create a digital voucher having a value for a second user, the digital voucher being usable by the second user for remitting one or more transactions across participating parties that communicate with a payment network, the method comprising: generating, at a server for creating the digital voucher, a unique code of the digital voucher upon verification of a sufficient balance in the funding account, the unique code identifying an issuer party of the funding account and a payment network provider of the payment network, wherein the unique code is associated with a unique identifier of the second user.

According to a sixth aspect of the present invention, there is provided a computer readable medium comprising instructions which, when executed by a processor, make the processor perform a method for processing a digital voucher at a server that administers a payment network, the digital voucher being created for a second user based on a funding account of a first user, the digital voucher having a value for remitting a transaction for the second user at a participating party that communicates with a payment network, the method comprising: validating the digital voucher upon verification of a unique code of the digital voucher based on a unique identifier of the second user, the unique code identifying an issuer party of the funding account and a payment network provider of the payment network; and authorising the remittance of the transaction with at least a portion of the value of the digital voucher, wherein the at least a portion of the value is deducted from a blocked fund in the funding account at a server that administers the issuer party of the funding account.

### BRIEF DESCRIPTION OF THE DRAWINGS

Embodiments of the invention will be better understood and readily apparent to one of ordinary skilled in the art from the following written description, by way of example only, and in conjunction with the drawings, in which:

FIG. 1 shows a flowchart depicting a method for utilising a funding account of a first user to create a digital voucher having a value for a second user, the digital voucher being usable by the second user for remitting one or more transactions across participating parties that communicate with a payment network.

FIG. 2 shows a flowchart depicting a method for processing a digital voucher at a server that administers a payment network, the digital voucher being created for a second user based on a funding account of a first user, the digital voucher having a value for remitting a transaction for the second user at a participating party that communicates with a payment network.

FIG. 3 shows an exemplary server that can be configured as a server for creating a digital voucher as depicted in FIG. 1 or a server for processing a digital voucher as depicted in FIG. 2, or a payment server as depicted in FIG. 7, according to various embodiments;

FIG. 4A shows an illustration of information flow in an embodiment of a system for creating and processing a digital voucher, in which the steps as depicted in FIG. 1 can be implemented.

FIG. 4B shows a schematic of the system as depicted in FIG. 4A, in which the step of the method as depicted in FIG. 1 are performed. The schematic illustrates a transaction flow between a server for creating a digital voucher having a value based on a funding account, a mobile application of a first user who owns the funding account, and a second user to whom the created digital voucher is assigned.

FIG. 5A shows an illustration of information flow in another embodiment of a system for creating and processing a digital voucher, in which the steps as depicted in FIG. 1 can be implemented.

FIG. 5B shows a schematic of the system as depicted in FIG. 5A, in which the step of the method as depicted in FIG. 1 are performed. The schematic illustrates a transaction flow between a server for creating a digital voucher having a value based on a funding account, a mobile application of a first user who owns the funding account, and a second user to whom the created digital voucher is assigned.

FIG. 6 shows an embodiment of a profile of a digital voucher, in which the funding account, the digital voucher and a further digital voucher are interlinked.

FIG. 7 shows an illustration of information flow in an embodiment of a system for creating and processing a digital voucher, in which the steps as depicted in FIG. 2 can be implemented.

FIG. 8 shows an exemplary computing device 800 to realize a server for creating a digital voucher, or a server for processing a digital voucher, or a payment server, in accordance with the embodiments shown in FIGS. 1 to 7. The server for creating a digital voucher and the server for processing a digital voucher credit can be the same server (for example, a server that administers a payment network) according to various embodiments.

FIG. 9 shows a schematic of modules in payment network server 406, 456, 506, 556, 706 of FIGS. 4A, 4B, 5A, 5B and 7 and how they function to create and/or process a digital voucher according to various embodiments.

### DETAILED DESCRIPTION

Overview

Various embodiments provide systems and methods for creating and processing a digital voucher.

The systems and methods according to various embodiments creates a digital voucher for people who do not have any saving accounts, credit or debit card accounts, or pre-paid payment card accounts with any financial institutions. The digital voucher is created using a funding account of a first user issued by an issuer party (for example, a bank or a financial intermediary that takes part in monetary transactions, such as MasterCard, Visa, or other payment network providers) for a second user who does not own any saving accounts, credit or debit card accounts, or pre-paid payment card accounts with the issuer party. The digital voucher has a certain amount of value that can be used for remitting one or more transactions across participating parties that communicate with a payment network.

According to practical needs, the digital voucher can be created by a server for creating the digital voucher, which may be implemented by a server of the payment network (which may be interchangeably referred to as a “payment network server” in the present application), a server of the issuer party (which may be interchangeably referred to as an “issuer server” in the present application), or a stand-alone server specially designated for creating and processing digital vouchers.

To track the creation and/or usage history of the digital voucher, the server for creating the digital voucher generates a unique code for the digital voucher to identify the payment network and the issuer party of the first user's funding account.

Further, to identify and verify the second user who does not own any saving accounts, credit or debit card accounts, or pre-paid payment card accounts with the issuer party, the server for creating the digital voucher associates the unique code of the digital voucher with a unique identifier of the second user. The unique identifier can be any reference that uniquely identifies the second user. For example, the unique identifier can be a phone number, an email address, an identification number issued by government authorities, and/or the like, of the second user. In an example, the identification number of the second user can be issued by government authorities with whom the second user has registered his/her biometric data, e.g. an Aadhaar number, which is a 12 digit unique-identity number issued to Indian residents based on their biometric and demographic data that is collected and managed by the Unique Identification Authority of India (UIDAI).

Advantageously, the association with the unique identifier is such that the generated unique code of the digital voucher is linked to the unique identifier of the second user, whereby when processing the digital voucher for remitting a transaction, a point of sale (POS) terminal, an automated teller machine (ATM) or a payment/check-out application is able to check with the payment network server to validate the digital voucher upon verification of the unique code of the digital voucher through authenticating the user of the digital voucher. In the present application, the “user of the digital voucher” can be interchangeably referred to as the “second user”. It is the unique code that the POS terminal or the ATM transmits to the payment network server to collect the payment for the transactions made using the digital voucher.

In some examples, the first user's funding account can be a credit account, a debit account, a saving account, a pre-paid account issued to a funding account owner by an issuer party pursuant to rules of certain financial institutions and/or payment schemes (e.g. Mastercard® International Incorporated rules).

In some examples, the first user's funding account can be another digital voucher that is generated by the server for creating the digital voucher based on another funding account issued by the issuer party.

Advantageously, upon generation of the unique code of the digital voucher, the digital voucher of the second user can be recorded into a profile of the funding account of the first user at a database of the payment network server or the issuer server. In this manner, profiles of different generations of digital vouchers can be advantageously interlinked, such that the initial source of funding account of a digital voucher can be tracked.

Advantageously, with the systems and methods according to various embodiments, people who do not own any saving accounts, credit or debit card accounts, or pre-paid payment card accounts with banks or any financial intermediaries are able to participate in card transactions and card-less digital wallet transactions, and to withdraw cash from ATM machines by verification of the unique code of the digital voucher through authenticating their unique identifiers (e.g. phone numbers, identification numbers, etc).

Terms Description (in Addition to Plain and Dictionary Meaning of Terms)

In the present disclosure, the term “digital voucher” refers to a monetary retainer having a certain amount of value that can be used for remitting one or more transactions across participating parties that communicate with a payment network. The “digital voucher” may include a digital form of bank notes, a form of transferable funds, etc. Non-limiting examples of a digital voucher include a digital currency, a token, an E-currency, etc. The digital voucher can be used in its digital form, or can be printed out and be used in a paper form.

In the present disclosure, the term “one or more transactions” refers to card transactions and card-less digital wallet transactions, such as automated teller machine (ATM) cash withdrawals, point of sale (POS) transactions, and/or digital payments made online or via mobile applications.

In the present disclosure, the term “funding account” refers to a financial account that can be used to fund the digital voucher. In the present disclosure, the funding account is owned by a first user and is utilised to create one or more digital vouchers for a second user and/or further users who does not have any saving accounts, credit or debit card accounts, or pre-paid payment card accounts with any financial institutions. Some examples of a funding account include a credit account, a debit account, a saving account, a pre-paid account issued to a funding account owner by an issuer party pursuant to rules of certain financial institutions and/or payment schemes (e.g. Mastercard® International Incorporated rules). In various embodiments, the credit account, the debit account, and the pre-paid account are usually issued with a payment card, thus may be interchangeably referred to as a “payment card account”. Further examples of a funding account include another digital voucher that is generated based on another funding account issued by the issuer party.

In the present disclosure, the term “unique code” refers to a reference of the digital voucher that identifies a payment network provider of the payment network and the issuer party of the funding account. In some examples, the unique code can be a sixteen-digit string generated by the payment network server or an issuer server based on a primary account number (PAN) of the funding account. In one embodiment, the string is generated using the PAN of the funding account of the first user. In another embodiment, the string is generated using a unique code of another digital voucher which, as described above, is generated earlier based on the PAN of the funding account of the first user. In yet another embodiment, the string is generated using a unique identifier of a user of the digital voucher along with the PAN of the funding account of the first user or the unique code of another digital voucher.

In the present disclosure, the term “unique identifier” refers to any reference that uniquely identifies a user of the digital voucher. The user of the digital voucher can be interchangeably referred to as a “second user”. For example, the unique identifier can be a phone number, an email address, an identification number issued by government authorities, and/or the like, of the second user. In an example, the identification number of the second user can be issued by government authorities with whom the user has registered his/her biometric data, such as an Aadhaar number, which is a 12 digit unique-identity number issued to Indian residents based on their biometric and demographic data that is collected and managed by the Unique Identification Authority of India (UIDAI).

In the present disclosure, the term “user of the digital voucher” and the term “second user” can be interchangeably referred to as a “Beneficiary”.

In the present disclosure, the term “remitting one or more transactions” or “remittance of one or more transactions” refers to a process where payments of the one or more transactions are made. In various examples of the present disclosure, the remittance of one or more transactions is made by the second user using the digital voucher having a value at one or more participating parties that communicate with the payment network. It is appreciable to those skilled in the art that the remittance can only be approved when the total amount of the one or more transactions is not more than the value of the digital voucher. After the remittance is approved, the amount of the one or more transactions is deducted from the funding account of the first user based on which the digital voucher is created for the second user, and is credited to the respective accounts at acquirer servers of the one or more participating parties via the payment network.

### EXEMPLARY EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “creating”, “generating”, “associating”, “recording”, “activating”, “deducting”, “blocking”, “providing”, “distributing”, “validating”, “authorising” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

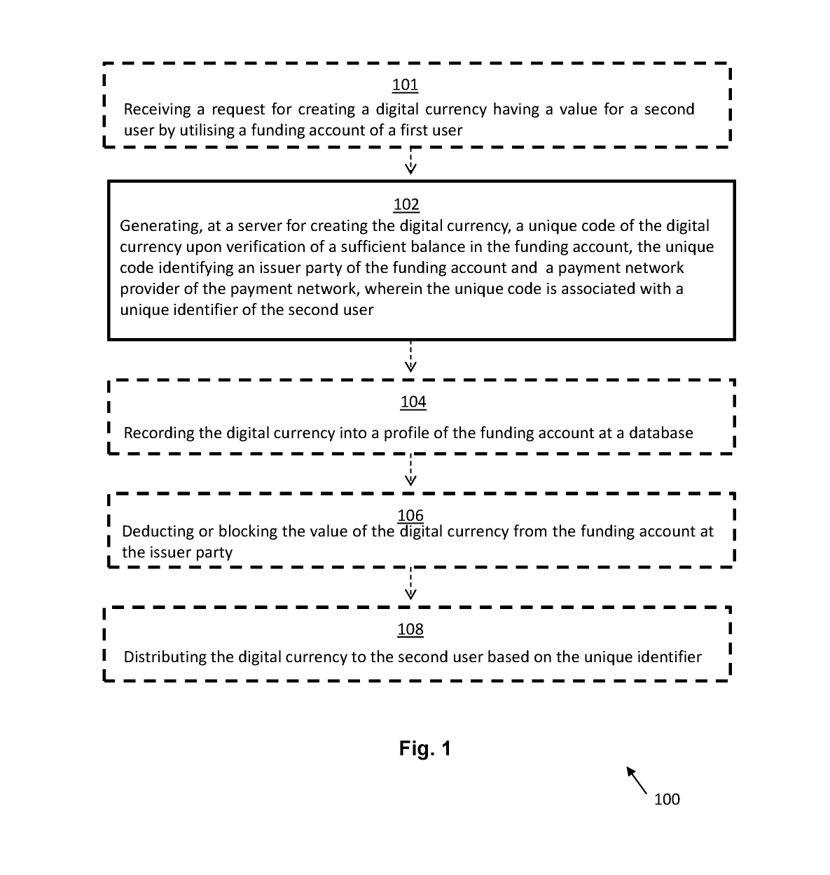

FIG. 1 shows a flow diagram 100 illustrating a method 100 for creating a digital voucher for a second user having a value based on a funding account of a first user. According to various embodiments, the digital voucher can be referred to as a digital currency, a token, an E-currency, etc. The digital voucher is usable by the second user for remitting one or more transactions across participating parties that communicate with a payment network. The method 100 can be a computer-implemented method. As described above, the term “the second user” can be interchangeably referred to as “the user of the digital voucher” or “Beneficiary”.

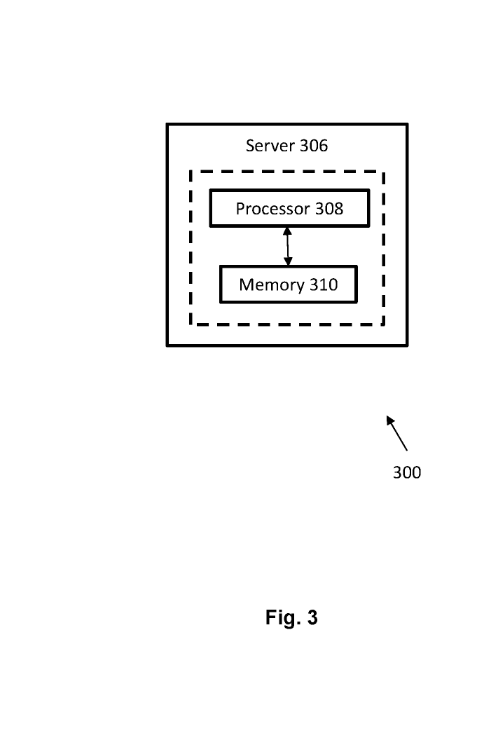

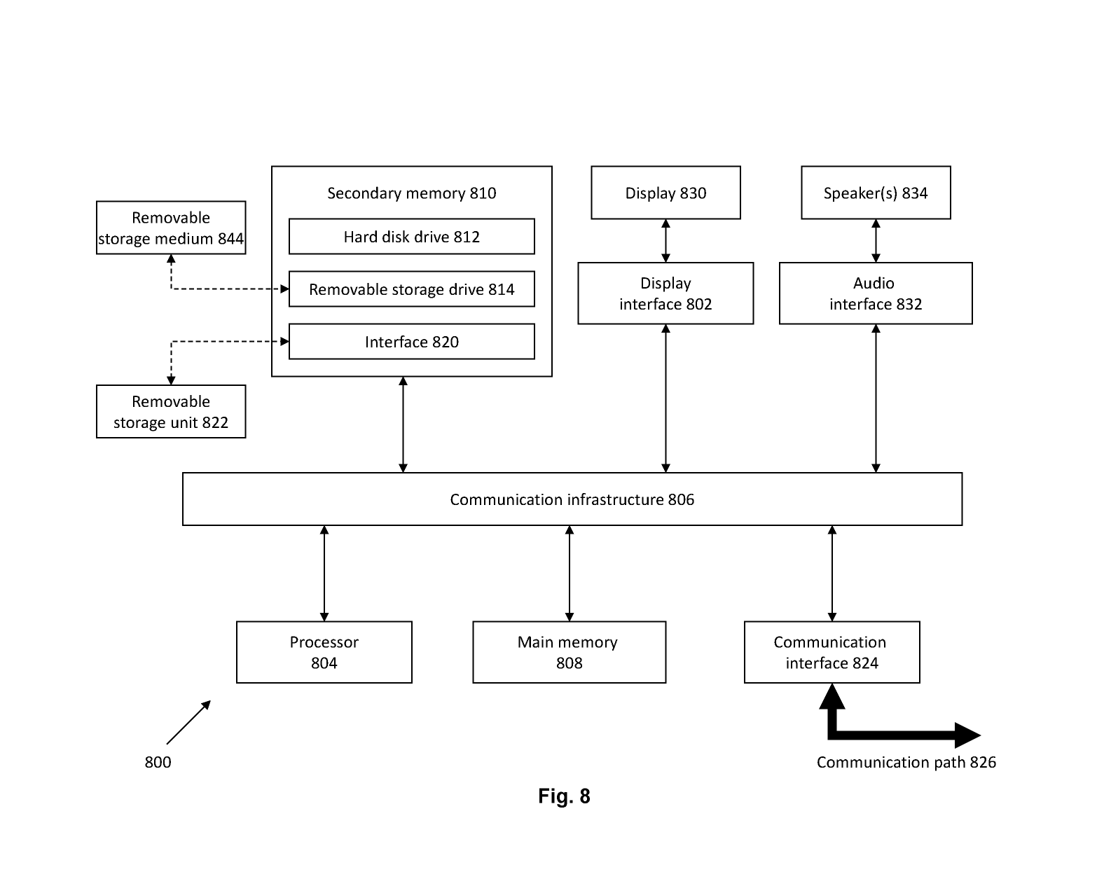

According to various embodiments, the method 100 can be implemented on a server for creating a digital voucher. In the embodiment shown in FIG. 1, the server for creating a digital voucher is implemented by a server that administers the payment network (which may be interchangeably referred to as a “payment network server” in the present application). It is appreciable to a skilled person in the art that the server for creating a digital voucher can also be implemented by a server that administers an issuer party of the funding account (which may be interchangeably referred to as an “issuer server” in the present application). Details of the server for creating a digital voucher according to various embodiments will be described with respect to FIGS. 3 and 8.

The method 100 includes:
step 102: generating, at a server for creating the digital voucher, a unique code of the digital voucher upon verification of a sufficient balance in the funding account, the unique code identifying an issuer party of the funding account and a payment network provider of the payment network, wherein the unique code is associated with a unique identifier of the second user.

In step 102, a unique code of a digital voucher is generated by the server for creating a digital voucher (e.g. the payment network server or the issuer server) based on a funding account of the first user issued by an issuer party (for example, a bank or a financial intermediary that takes part in monetary transactions). For example, the funding account can be a credit account, a debit account, a saving account, a pre-paid account issued to a funding account owner by an issuer party pursuant to rules of certain financial institutions and/or payment schemes (e.g. Mastercard® International Incorporated rules). In various embodiments, the credit account, the debit account, and the pre-paid account are usually issued with a payment card, thus may be interchangeably referred to as a “payment card account”. On the other hand, it can be appreciated by the skilled person in the art that the saving account may not be issued with a payment card. In various embodiments, the funding account can be another digital voucher that is generated by the server for creating a digital voucher based on another funding account issued by the issuer party.

As described above, it is appreciable to the skilled person in the art that, alternative to the payment network server, the issuer server may alternatively serve as the server for creating a digital voucher according to various implementations of the method 100.

In the method 101, step 102 may be activated in response to a step 101. In step 101 as shown in FIG. 1, according to various embodiments, the step 102 of generating the unique code may be activated by the server for creating a digital voucher (e.g. the payment network server or the issuer server) in response to receipt of a request from the issuer server for creating the digital voucher having the value.

Alternatively, in the step 101, according to various embodiments, the step 102 of generating the unique code may be activated by the server for creating a digital voucher (e.g. the payment network server or the issuer server) in response to receipt of a request from a server that administers a website or a mobile application of the payment network for creating the digital voucher having the value.

In scenarios of step 102 where the payment network server is the server for creating a digital voucher, the payment network server checks with the issuer server to verify if the funding account has a sufficient balance that is not less than the value of the digital voucher as indicated in the request (either from the issuer server or from the server that administers a website or a mobile application of the payment network), and creates the digital voucher when the issuer server confirms that the funding account indeed has a sufficient balance. Alternatively, in scenarios where the issuer server is the server for creating a digital voucher, the issuer server checks with its database to verify if the funding account has a sufficient balance that is not less than the value of the digital voucher as indicated in the request (either from the issuer server or from the server that administers a website or a mobile application of the payment network), and creates the digital voucher when the funding account indeed has a sufficient balance. The payment network server along with the issuer server and a server that administers an acquirer party (which may be interchangeably referred to as an “acquirer server” in the present application) underlie the existing authentication, clearing and settlement programs in the payment network to authenticate a funding account owner during a transaction. For the sake of simplicity, the underlying authentication, clearing and settlement programs in the payment network will not be described herein.

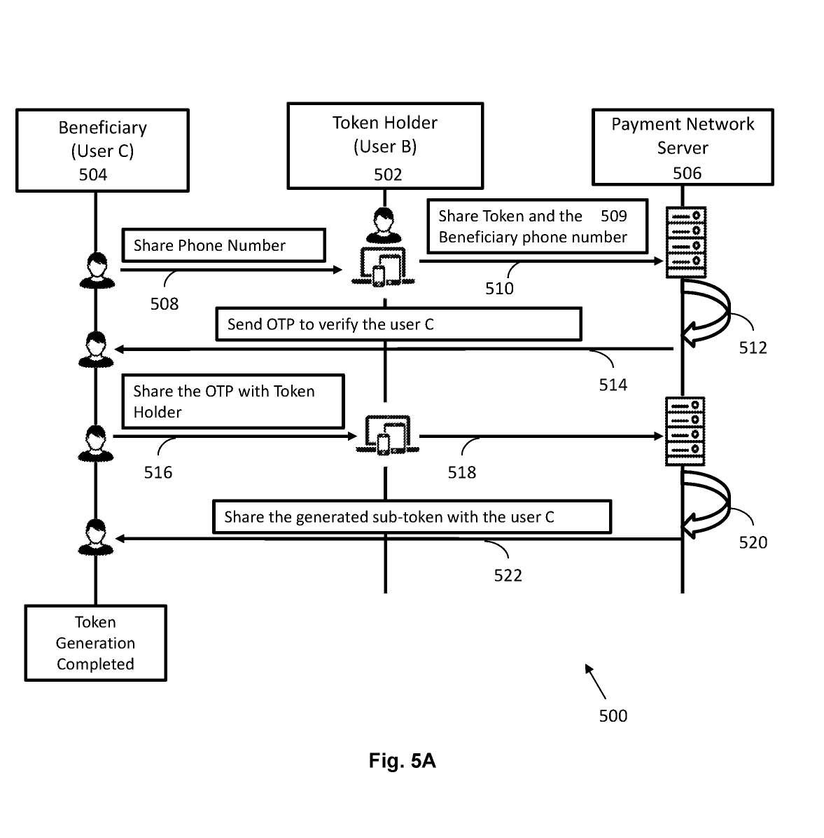

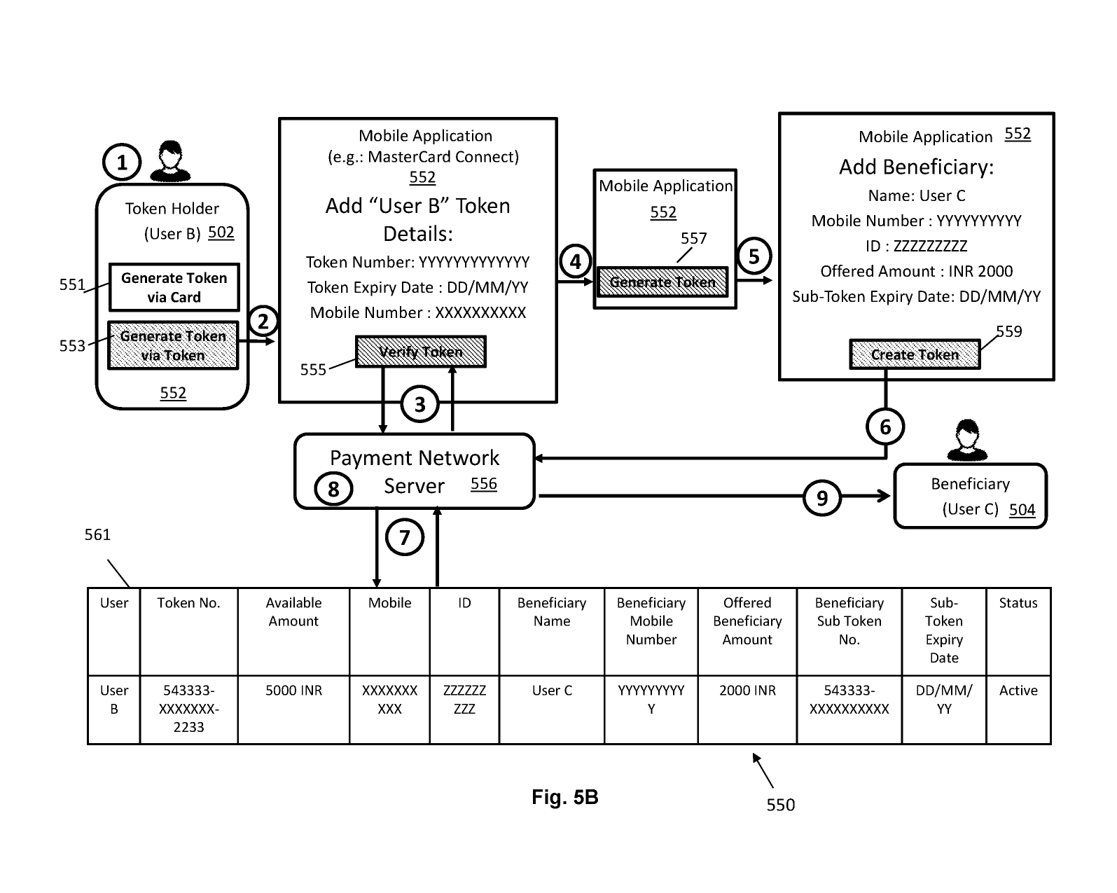

The unique code of the digital voucher identifies the payment network provider and the issuer party of the funding account. According to various embodiments, the unique code can be a sixteen-digit string generated by the payment network server based on a primary account number (PAN) of the funding account. A portion of this unique code is fixed as it is needed to identify the payment network in which the digital voucher can be used and the issuer party of the funding account. For example, in an exemplified unique code “543333-XXXXXXXXXX” shown in FIG. 5B, the first six digits of the unique code indicate the Issuer Identification number and the very first digit indicates the payment network provider, while the remainder is randomly generated. The PAN refers to a number of digits (or characters) which identify the funding account. In some embodiments, the PAN may be a twelve to nineteen-digit string, usually sixteen digits, that identifies both the issuing party (e.g. which may be based on the first few digits of the string, for example, the first five to ten digits) and the specific account (e.g. which may be based on some or all of the remaining digits). In the present application, the PAN can be interchangeably referred to as a “card number”.

The unique code of the digital voucher is associated with a unique identifier of a user of the digital voucher. In the present application, the user of the digital voucher can be interchangeably referred to as a “Beneficiary” in the present application. In various embodiments, the user of the digital voucher is different from the owner of the funding account. Alternatively, the user of the digital voucher can be the owner of the funding account. The association with the unique identifier is such that the generated unique code of the digital voucher is linked to the unique identifier, whereby a point of sale (POS) terminal or an automated teller machine (ATM) is able to check with the payment network server to validate the digital voucher upon verification of the unique code of the digital voucher through authenticating the user of the digital voucher when processing the digital voucher for remitting a transaction. It is the unique code that the POS terminal or the ATM transmits to the payment network server to collect the payment for the transactions made using the digital voucher.

According to various embodiments, the unique identifier of the user of the digital voucher comprises a phone number of the user of the digital voucher. According to various embodiments, the unique identifier of the user of the digital voucher may further comprise an identification number that is associated with biometric data of the user of the digital voucher. The identification number that is associated with biometric data of the user of the digital voucher can be an Aadhaar number, which is a 12 digit unique-identity number issued to Indian residents based on their biometric and demographic data that is collected and managed by the Unique Identification Authority of India (UIDAI). It is appreciable to the skilled person in the art that the identification number that is associated with biometric data of the user of the digital voucher can be in other forms in addition to Aadhaar.

The method 101 may further comprise a step 104. In step 104, according to various embodiments, upon generation of the unique code of the digital voucher in step 102, the digital voucher can be recorded into a profile of the funding account at a database of the payment network server. Alternatively or additionally, the digital voucher can be recorded into a profile of the funding account at a database of the issuer server.

In the database, the digital voucher can be mapped with the funding account upon which the digital voucher is created. For example, the unique code of the digital voucher can be stored into a portion of the database where the PAN of the funding account is stored to allow identification of the PAN number to which the unique code of the digital voucher corresponds or linked. In this manner, the unique code of the digital voucher is mapped/linked to the funding account.

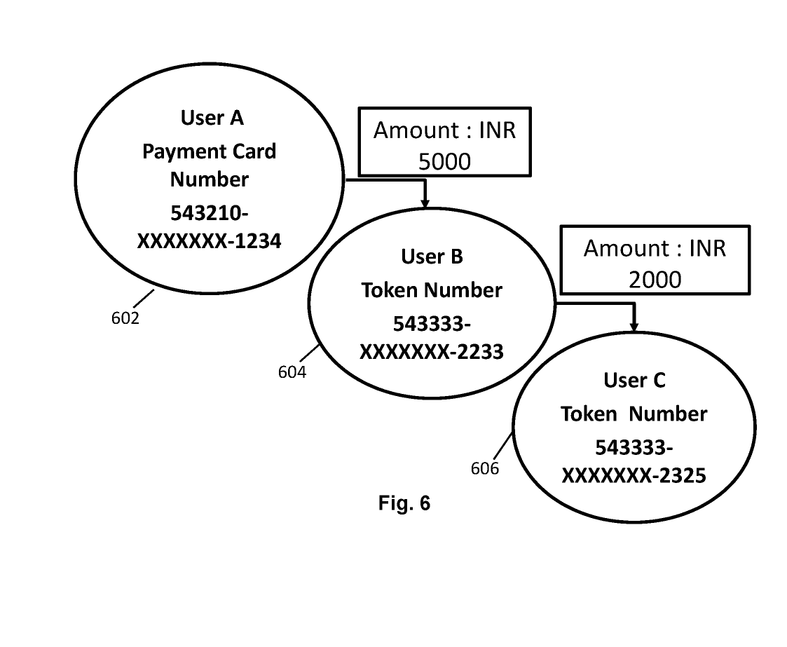

When the funding account of the digital voucher is another digital voucher created based on another funding account, the digital voucher can be recorded into a profile of the other funding account at the database of the payment network server or the issuer server. Alternatively or additionally, in such scenario, the digital voucher can be also recorded into a profile of the funding account at the database of the payment network server or the issuer server. Advantageously in this manner, the profiles of different generations of digital vouchers are interlinked, such that the initial source of funding account of a digital voucher can be tracked. An embodiment of the interlinked profiles of different generations of digital vouchers is shown in FIG. 6.

The method 101 may further comprise a step 106. In step 106, according to various embodiments, upon generation of the unique code of the digital voucher, the value of the digital voucher may be deducted from the funding account at the issuer server.

Alternatively, in step 106, according to various embodiments, upon generation of the unique code, the value of the digital voucher can be blocked from the funding account at the issuer server. The blocked value will be partially or fully deducted from the funding account by the issuer server at the time of remitting the one or more transactions using the digital voucher.

The method 101 may further comprise a step 108. In step 108, according to various embodiments in which the unique code is generated by the payment network server, the unique code can be distributed by the payment network server to the user of the digital voucher based on the unique identifier. Alternatively, the unique code can be provided from the payment network server to the issuer server, which in turn distributes unique code to the user of the digital voucher based on the unique identifier.

It can be appreciated by the skilled person in the art that when the unique code is generated by the issuer server, the unique code can be distributed by the issuer server to the user of the digital voucher based on the unique identifier. Alternatively, the unique code can be provided from the issuer server to the payment network server, which in turn distributes unique code to the user of the digital voucher based on the unique identifier.

The digital vouchers generated as described above can be used to pay for one or more transactions across participating parties that communicate with the payment network. The one or more transactions include a cash withdrawal transaction at an ATM machine administered by the acquirer server in the payment network and/or a payment transaction at an acquirer party in the payment network. The payment transaction can be made at a website or an application administered by the acquirer server or made at a Point of Sale (POS) machine administered by the acquirer server.

In various embodiments, the server for creating a digital voucher (e.g. the payment network server or the issuer server) may be configured to set a validity period for the digital voucher or the owner (i.e. the first user) of the funding account can set this validity period at the time of creating the digital voucher. The validity period may be 1 day, 2 months, etc. In this manner, the digital voucher may be valid for use in the payment network until an expiry date from the time of creation. The validity period for the digital voucher can advantageously enhance the security of using the digital voucher.

In various embodiments, the server for creating a digital voucher (e.g. the payment network server or the issuer server) may be configured to set a limit or a maximum number of times for further digital vouchers to be created based on the digital voucher. The further digital vouchers may be interchangeably referred to as “sub-tokens” in the present application.

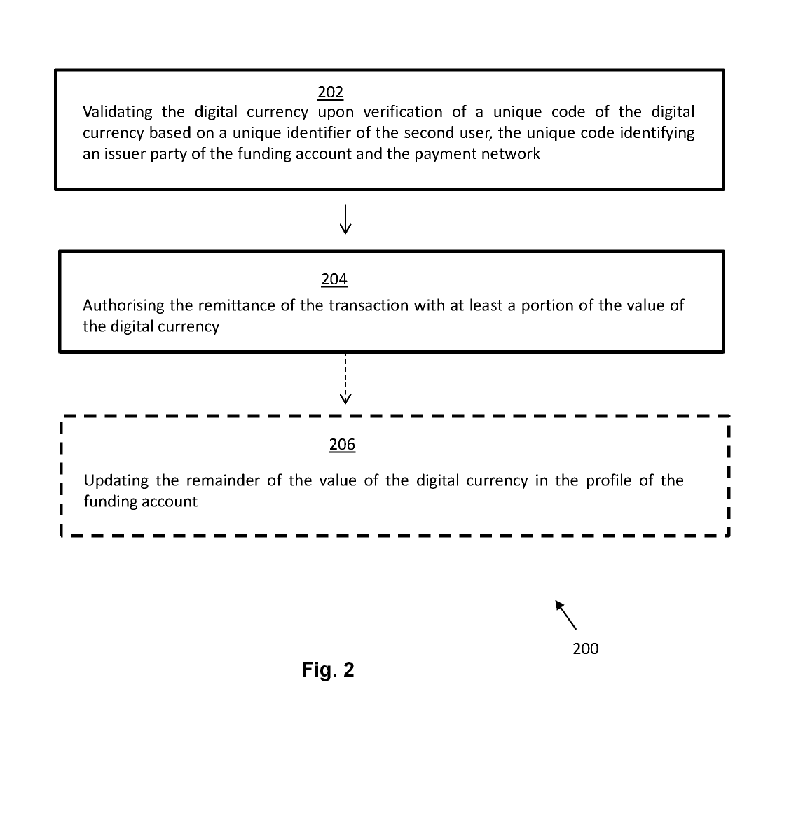

FIG. 2 shows a flow diagram 200 illustrating a method 200 for processing a digital voucher having a value when the digital voucher is used for remitting a transaction for the second user at a participating party that communicates with the payment network. According to various embodiments, the digital voucher can be referred to as a digital currency, a token, an E-currency, etc. The method 200 can be a computer-implemented method.

According to various embodiments, the method can be implemented on a server for processing a digital voucher. In the embodiment shown in FIG. 2, the server for processing a digital voucher is implemented by a payment network server as described above. It is appreciable to a skilled person in the art that the server for processing a digital voucher can also be implemented by an acquirer server. Details of the server for processing a digital voucher according to various embodiments will be described with respect to FIGS. 3 and 8.

The method 200 includes:
step 202: validating the digital voucher upon verification of a unique code of the digital voucher based on a unique identifier of a user of the digital voucher; and
step 204: authorising the remittance of the transaction with at least a portion of the value of the digital voucher, wherein the at least a portion of the value is deducted from a blocked fund in a funding account based on which the digital voucher is created, at a server that administers an issuer party of the funding account.

In step 202, the payment network server validates a digital voucher upon verification of the unique code of the digital voucher as generated in step 102 based on a unique identifier of a user of the digital voucher. In the present application, the unique code of the digital voucher is linked to the unique identifier of the user of the digital voucher, whereby the payment network server is able to validate the digital voucher upon verification of the unique code of the digital voucher through authenticating the user of the digital voucher based on the unique identifier when processing the digital voucher for remitting a transaction.

According to various embodiments, the unique identifier comprises a phone number of the user of the digital voucher. Alternatively or additionally, the unique identifier comprises an identification number that is associated with biometric data of the user of the digital voucher. The identification number that is associated with biometric data of the user of the digital voucher can be an Aadhaar number, which is a 12 digit unique-identity number issued to Indian residents based on their biometric and demographic data that is collected and managed by the Unique Identification Authority of India (UIDAI). It is appreciable to the skilled person in the art that the identification number that is associated with biometric data of the user of the digital voucher can be in other forms in addition to Aadhaar.

In an embodiment of step 202, the payment network server firstly verifies the unique code of the digital voucher with a database of the payment network. The verification of the unique code of the digital voucher may involve comparing a requested value for remittance using the digital voucher with the value of the digital voucher that is recorded in a profile of the funding account at the database.

Additionally, the verification of the unique code may involve comparing a date on which the digital voucher is used with an expiry date that is set to the digital voucher upon generation. Then, the payment network server authenticates the user of the digital voucher by verifying the unique identifier of the user. In an embodiment, if the unique identifier is a phone number of the user, the phone number of the user may have been recorded in the profile of the funding account in the database during the digital voucher creation process as described with respect to FIG. 1. In step 202, the payment network server may generate an one time password (OTP) and send to the phone number of the user that is recorded in the profile of the funding account in the database. If the user of the digital voucher is able to prove to the payment network server that he/she has received the correct OTP, the digital voucher can then be validated. In an alternative embodiment, if the unique identifier is an identification number that is associated with biometric data of the user of the digital voucher (e.g. Aadhaar number of the user), the payment network server can authenticate the user of the digital voucher by verifying the biometric data of the user at a website of the Unique Identification Authority of India (UIDAI) based on the Aadhaar number. This alternative embodiment may require a POS terminal or an ATM machine of the acquirer server or a mobile device of the user of the digital voucher to furnish a biometric data collector, such as a retinal scanner or a fingerprint scanner, such that the biometric data of the user of the digital voucher can be collected by the biometric data collector and forwarded to the UIDAI for authentication based on the Aadhaar number of the user.

In step 204, if the digital voucher is validated, the payment network server proceeds to authorise the remittance of the transaction with at least a portion of the value of the digital voucher. The at least a portion of the value is deducted from a blocked fund in the funding account at the issuer server. The fund was blocked in consequence to the generation of the unique number of the digital voucher during the digital voucher creation process as described with respect to FIG. 1.

The method 200 may further comprise a step 206. In step 206, according to various embodiments, after deducting the at least a portion of the value of the digital voucher, the payment network server updates the remainder of the value of the digital voucher in the profile of the funding account at the database in the payment network server. It can be appreciated by the skilled person in the art that the remainder of the value of the digital voucher may also be updated in a profile of the funding account at a database in the issuer server.

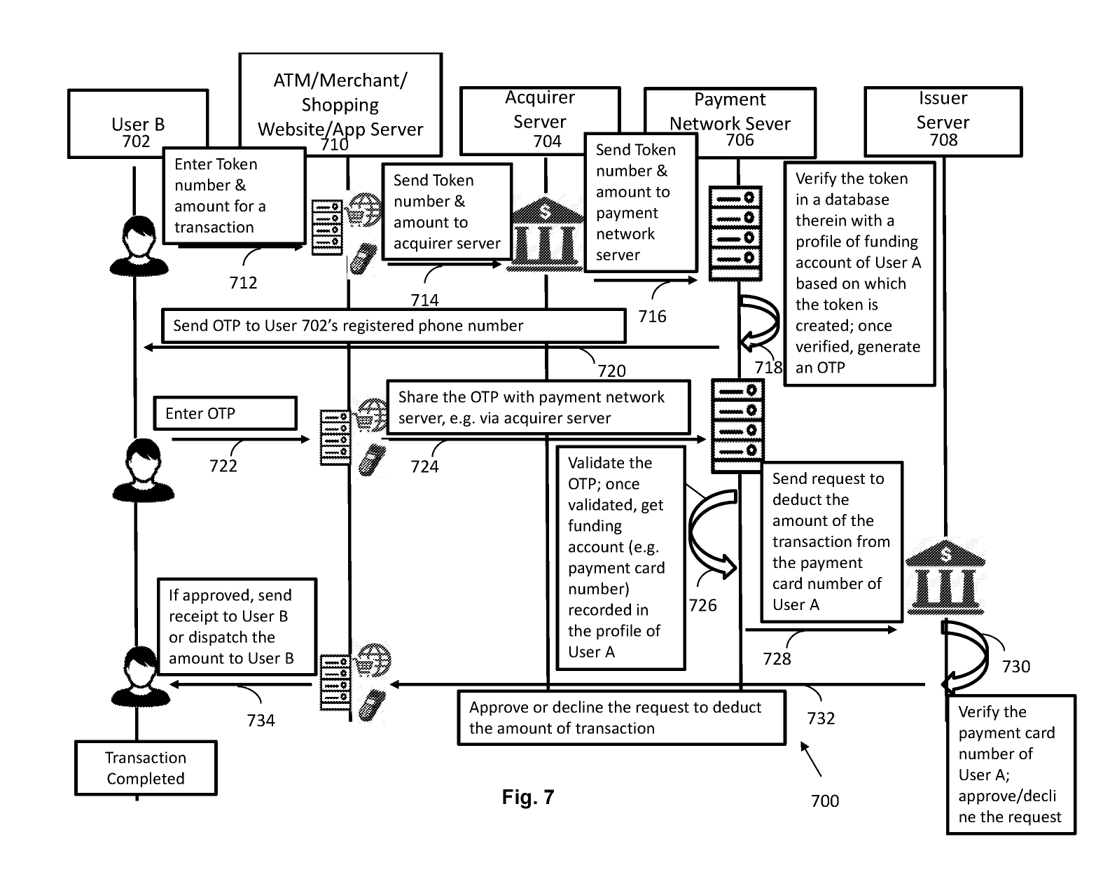

FIG. 3 shows a schematic diagram 300 of a server 306 that can be configured as to a server for creating a digital voucher and a server for processing a digital voucher in accordance with the embodiments of the invention. As described above, the server 306 can be implemented as the payment network server or the issuer server to create a digital voucher as described with respect to FIG. 1. Alternatively, the server 306 may be implemented as the payment network server or the acquirer server as described with respect to FIG. 2. In addition, the server 306 may be implemented as a payment server that administers an ATM, a POS terminal or a payment application and communicates with the acquirer server for payment of transactions as illustrated in FIG. 7.The server 306 comprises at least one processor 308 and at least one memory 310 including computer program code (not shown).

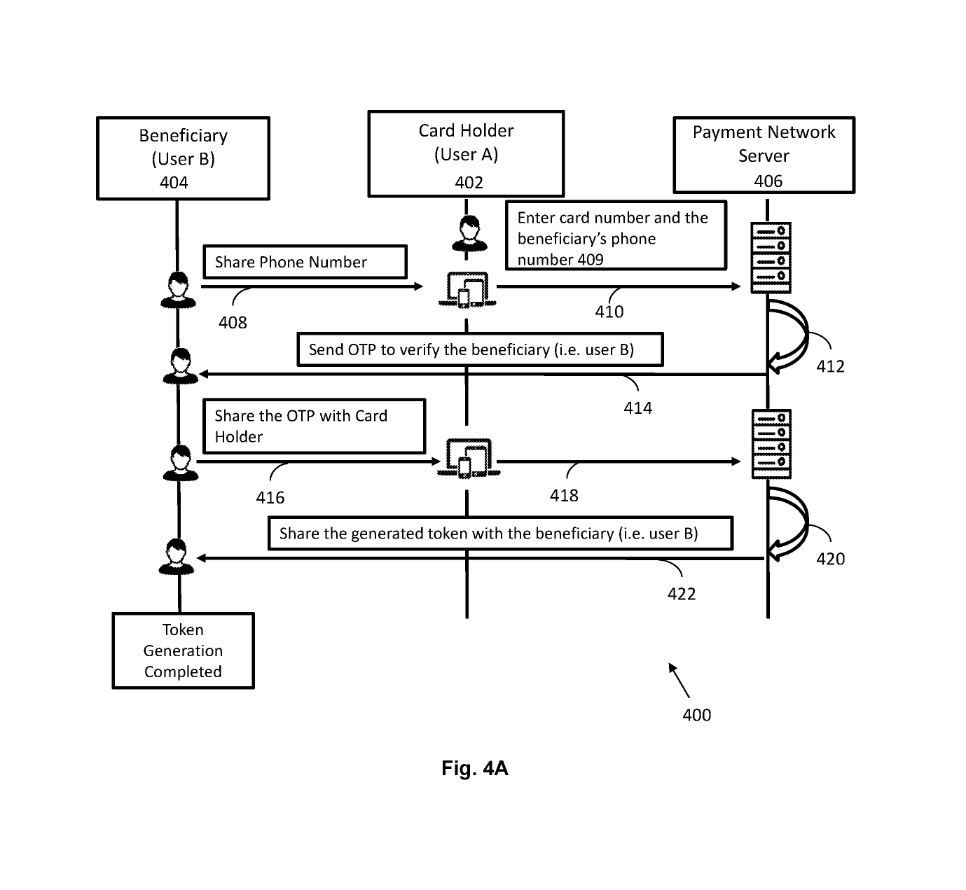

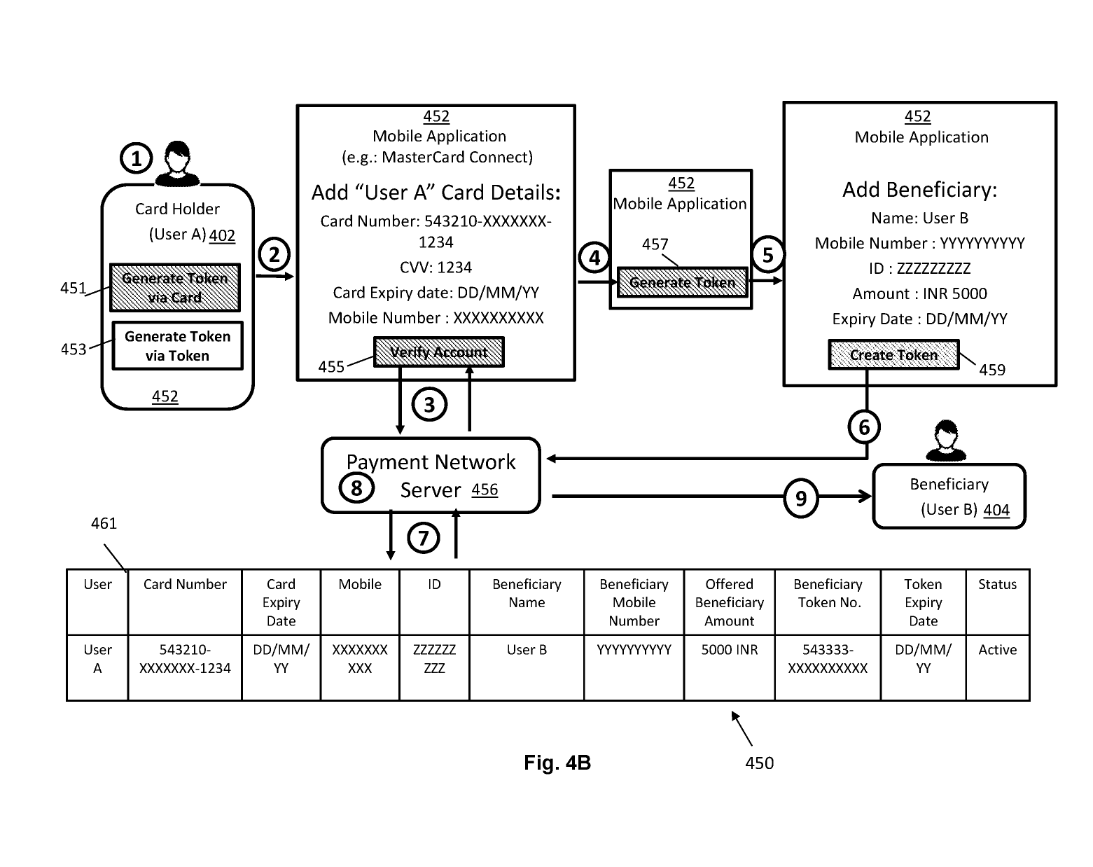

The at least one memory 310 and the computer program code configured to, with the at least one processor 308, cause the server 306 at least to perform the step as described with regard to the above described FIG. 1 and FIG. 2 and the following described FIGS. 4A, 4B, 5A, 5B and 7.

FIG. 4A shows an illustration of information flow in an embodiment of a system 400 for creating and processing a digital voucher for a beneficiary (interchangeably referred to as “User B”) based on a funding account of a funding account holder (interchangeably referred to as “User A”), in which the step as depicted in FIG. 1 can be implemented.

In the present embodiment, the system 400 comprises a funding account holder (i.e. User A) 402 of a funding account (not shown in FIG. 4A) issued by an issuer party (not shown in FIG. 4A), a recipient 404 of a digital voucher having a value based on the funding account (i.e. User B or Beneficiary), and a server 406 that administers a payment network (i.e. payment network server 406). In the present embodiment, the funding account is a payment card account. It can be appreciated by the skilled person that the funding account can also be in other forms, such as a saving account that is not accompanied with a payment card.

The present embodiment relates to a scenario where a request 409 for creating a digital voucher (not shown in FIG. 4A) of a value based on the funding account is made by User A 402 at a website of the payment network. The website is accessible by User A 402 through the Internet on an electronic device such as a computer, a mobile phone, a tablet, and the like. The value may be for example, 5000 Indian Rupee (INR).

Alternatively, the request 409 for creating the digital voucher may be made by User A 402 on a software application (hereinafter interchangeably referred to as an “App” in the present application) of the payment network. The software application (which may be interchangeably referred to as an “App” in the present application) is installed and run on an electronic device as mentioned above, for example on an mobile phone, which upon clicking or upon logging in, may allow users to manage one or more funding accounts that are registered with the App. The App includes Masterpass, MasterCard Connect or any other similar payment network applications.

In the present embodiment, it is also appreciable to the skilled person that the request 409 for creating the digital voucher may be made by User A 402 at a website or an App of the issuer party (not shown in FIG. 4A).

In step 410, User A 402 transmits the request 409 to the payment network server 406 for creating the digital voucher. The request 409 may include an account number of User A′s 402 funding account and a unique identifier of User B 404. In the present embodiment, the unique identifier of User B 404 is a phone number of User B 404, and the account number of User A's 402 funding account is a card number of the funding account. It can be appreciated by the skilled person that the unique identifier of User B 404 may be an identification number that is associated with biometric data of User B 404 (e.g. an Aadhaar number of User B 404). The phone number of User B 404 may be shared by User B 404 to User A 402 in a step 408 prior to or in the meanwhile as step 410. The request 409 may also include the value of the digital voucher.

In step 412, the payment network server 406 may generate an one time password (OTP). The OTP may be sent in step 414 to the phone number of User B 404 to verify User B 404.

In step 416, User B 404 may share the OTP with User A 402. Upon successful receipt of the OTP from User B 404, User A 402 may forward the OTP to the payment network server 406 in step 418.

If the OTP forwarded from User A in step 418 tally with the OTP generated by the payment network server 406 in step 412, the phone number of User B 404 is verified. In consequence, step 420 can be activated at the payment network 406 to generate a unique code of the digital voucher with the value (interchangeably referred to as a “token”). Step 420 corresponds to step 102 as depicted in FIG. 1. The unique code of the digital voucher identifies the issuer party of the funding account and the payment network, and is associated with the unique identifier (e.g. the phone number) of User B 404. In various embodiments, the payment network may map (not shown in FIG. 4A) the unique code of the digital voucher to link to User A's 402 funding account, and block the value from User A's 402 funding account. Although the issuer party is not shown in FIG. 4A, it is appreciable to the skilled person in the art that prior to step 420, the payment network server 406 may have checked with the issuer party to verify whether the funding account has a sufficient balance that is not less than the value of the digital voucher indicated in the request 409 the present embodiment, e.g. 5000 INR.

In step 422, the generated unique code of the digital voucher can be distributed by the payment network server 406 to User B 404 based on the phone number of User B 404. The unique code of the digital voucher can be later used by User B 404 to remit for any transactions instead of cash.

FIG. 4B shows a schematic 450 of the system as depicted in FIG. 4A, in which the step 102 of the method 100 as depicted in FIG. 1 is performed. In particular, the schematic 450 relates to a scenario where User A 402 uses a software application (hereinafter interchangeably referred to as an “App” in the present application) of the payment network to make a request 409 for creating a digital voucher based on a funding account of User A 402. It is appreciable to the skilled person that the request 409 may be created in other manners as described above.

In the present embodiment, the schematic 450 illustrates a transaction flow between a payment network server 456 for creating a digital voucher having a value based on a funding account of User A 402, a mobile application 452 of User A 402 who owns the funding account, and User B 404 to whom the created digital voucher is assigned. Various steps illustrated in FIG. 4B are indicated by encircled numbers (for example, a first step is indicated by an encircled number 1).

In a first step, User A 402 may select an option for generating the digital voucher (interchangeably referred to as a “token”) from the mobile application 452. As shown in FIG. 4B, there are two options 451, 453 provided for generating the token. Option 451 is for generating a token based on a payment card, whereas option 453 is for generating a token based on another token. In the present embodiment shown in FIG. 4B, User A selects option 451 to generate the present digital voucher/token based on a payment card.

After option 451 is selected, in a second step, the mobile application 452 is directed to a page where User A 402 is able to add card details. As shown in FIG.

4B, the card details include one or more of a card number, an expiry date of the card, a phone number of User A 402, and an anti-fraud security number of the card (e.g. a Card Verification Value (CVV) number). After the card details are added, option 455 may be selected.

In a third step, upon selection of option 455, the card details of User A 402 can be transmitted to the payment network server 456 (e.g. a MasterCard server) for verification of the card details at a database of the payment network server 456. It is appreciable to the skilled person that, although not shown in FIG. 4B, it is feasible for the payment network server 456 to forward the card details to an issuer party of the payment card for verification of the card details.

Upon successful verification of the card details of User A 402 from the third step, in a fourth step, the mobile application 452 is directed to a page where User A 402 is provided with option 457 to create the digital voucher/token.

After option 457 is selected, in a fifth step, the mobile application 452 is directed to a page where User A 402 is required to enter unique identifiers of User B 404 (i.e. beneficiary), such as name and mobile number of User B 404. Along with a value that User A 402 is willing to offer, there is an optional unique identifier field for an Identification (ID) number of User B 404. The ID number may be a regular ID number, e.g. a passport number. Alternatively, the ID number may be associated with biometric data of User B 404. For example, the ID number may be an Aadhaar number of User B 404.

Additionally in the fifth step, User A 402 may be able to indicate an expiry date for the digital voucher/token, which will allow User B 404 to use the digital voucher/token (which will be generated in the next step) for that period of time. After all the User B 404 details are entered in the fifth step, option 459 can be selected to request for generating a unique code of the digital voucher. The unique code of the digital voucher can be interchangeably referred to as a beneficiary token number.

In a sixth step, a request (not shown) is sent to the payment network server 456 to generate the unique code of the digital voucher. The unique code of the digital voucher identifies the issuer party of the funding account and the payment network, and is associated with the unique identifier (e.g. the phone number) of User B 404. it is appreciable to the skilled person in the art that prior to the sixth step, the payment network server 456 may have checked with the issuer party of the card to verify whether the card has a sufficient balance that is not less than the value of the digital voucher indicated in the request, e.g. 5000 INR. In addition, the payment network server 456 may generate an OTP for verification of User B's 404 phone number.

In a seventh step, prior to or in the meanwhile as the payment network server 456 generates the unique code of the digital voucher, the payment network server 456 may record the digital voucher into a database therein. Since the request for generating the unique code was originally raised by User A 402, the unique identifiers of User B 404 are associated with the unique code of the digital voucher and recorded into a profile 461 of the funding account of User A 402 (e.g. the card number of User A in the present embodiment). An example of the profile 461 of the funding account of User A 402 is shown in FIG. 4B, the content of which is self-explanatory.

In an eighth step, the payment network server 456 generates the unique code of the digital voucher. As described above, the unique code can be a sixteen-digit string generated by the payment network server 456 based on a card number of User A 402. A portion of this unique code is fixed as it is needed to identify the payment network in which the digital voucher can be used and the issuer party of the funding account. For example, FIG. 4B shows an exemplified unique code “543333-XXXXXXXXXX”, the first six digits of the unique code indicate an Issuer Identification number and the very first digit indicates the payment network, while the remainder is randomly generated.

In a ninth step, the generated unique code of the digital voucher may be distributed to User B 404 based on the phone number of User B 404.

FIG. 5A shows an illustration of information flow in another embodiment of a system 500 for creating and processing a digital voucher for a beneficiary (interchangeably referred to as “User C” in FIG. 5A) based on a funding account of a funding account holder (interchangeably referred to as “User B” in FIG. 5A, in which the step as depicted in FIG. 1 can be implemented.

In the present embodiment, the system 500 comprises a funding account holder (i.e. User B) 502 of a funding account (not shown in FIG. 5A) issued by an issuer party (not shown in FIG. 5A), a recipient 504 (i.e. User C or Beneficiary) of a digital voucher having a value based on the funding account, and a server 506 that administers a payment network (i.e. payment network server 506). In this embodiment, the funding account is another digital voucher that is generated by the payment network server based on another funding account issued by the issuer party.

Similar to FIG. 4A, the present embodiment relates to a scenario where a request 509 for creating a digital voucher (not shown in FIG. 5A) of a value based on the funding account is made by User B 502 at a website or an App of the payment network. The website or the App is accessible by User B 502 through the Internet on an electronic device such as a computer, a mobile phone, a tablet, and the like. The value may be for example, 2000 Indian Rupee (INR). The App includes Masterpass, MasterCard Connect or any other similar payment network applications.

In the present embodiment, it is also appreciable to the skilled person that the request 509 for creating the digital voucher may be made by User B 502 at a website or an App of the issuer party (not shown in FIG. 5A).

In step 510, User B 502 transmits the request 509 to the payment network server 506 for creating the digital voucher. The request 509 may include an account number of User B's 502 funding account and a unique identifier of User C 504. In the present embodiment, the unique identifier of User C 504 is a phone number of User C 504, and the account number of User B's 502 funding account is a card number of the funding account. It can be appreciated by the skilled person that the unique identifier of User C 504 may be an identification number that is associated with biometric data of User C 504 (e.g. an Aadhaar number of User C 504). The phone number of User C 504 may be shared by User C 504 to User B 502 in a step 508 prior to or in the meanwhile as step 510. The request 509 may also include the value of the digital voucher.

In step 512, the payment network server 506 may generate an one time password (OTP). The OTP may be sent in step 514 to the phone number of User C 504 to verify User C 504.

In step 516, User C 504 may share the OTP with User B 502. Upon successful receipt of the OTP from User C 504, User B 502 may forward the OTP to the payment network server 506 in step 518.

If the OTP forwarded from User B in step 518 tallies with the OTP generated by the payment network server 506 in step 512, the phone number of User C 504 is verified. In consequence, step 520 can be activated at the payment network 506 to generate a unique code of the digital voucher with the value (interchangeably referred to as a “sub-token” in FIG. 5A). Step 520 corresponds to step 102 as depicted in FIG. 1. The unique code of the digital voucher identifies the issuer party of the funding account and the payment network, and is associated with the unique identifier (e.g. the phone number) of User C 504. In various embodiments, the payment network may map (not shown in FIG. 5A) the unique code of the digital voucher to link to User B's 502 funding account, and block the value from User B's 502 funding account. As the funding account in the present embodiment is another digital voucher, it is appreciable to the skilled person in the art that prior to step 520, the payment network server 506 may have checked with a database therein to verify whether the funding account has a sufficient balance recorded in the database that is not less than the value of the digital voucher indicated in the request 509 the present embodiment, e.g. 2000 INR.

In step 522, the generated unique code of the digital voucher can be distributed by the payment network server 506 to User C 404 based on the phone number of User C 404. The unique code of the digital voucher can be later used by User C 404 to remit for any transactions across the payment network instead of cash.

FIG. 5B shows a schematic 550 of the system as depicted in FIG. 5A, in which the step of the method as depicted in FIG. 1 is performed. The schematic 550 relates to a scenario where User B 502 uses a software application (hereinafter interchangeably referred to as an “App” in the present application) of the payment network to make a request 509 for creating a digital voucher based on a funding account of User B 502.

In the present embodiment, the schematic 550 illustrates a transaction flow between a payment network server 556 for creating a digital voucher having a value based on a funding account of User B 502, a mobile application 552 of User B 502 who owns the funding account, and User C 504 to whom the created digital voucher is assigned. In the present embodiment, the funding account of User B 502 is another digital voucher that is generated by the payment network server 556 based on another funding account issued by the issuer party. Various steps illustrated in FIG. 5B are indicated by encircled numbers (for example, a first step is indicated by an encircled number 1).

In a first step, User B 502 may select an option for generating the digital voucher (interchangeably referred to as a “token”) from the mobile application 552. As shown in FIG. 5B, there are two options 551, 553 provided for generating the token. Option 551 is for generating a token based on a payment card, whereas option 553 is for generating a token based on another token. In the present embodiment shown in FIG. 5B, User B 502 selects option 553 to generate the present digital voucher/token based on another digital voucher.

After option 553 is selected, in a second step, the mobile application 552 is directed to a page where User B 502 is able to add token details (i.e. details of the other digital voucher). As shown in FIG. 5B, the token details include one or more of a token number, an expiry date of the token, and a phone number of User B 502. After the token details are added, option 555 may be selected.

In a third step, upon selection of option 555, the token details of User B 502 can be transmitted to the payment network server 556 (e.g. a MasterCard server) for verification of the token details at a database of the payment network server 556.

Upon successful verification of the token details of User B 502 from the third step, in a fourth step, the mobile application 552 is directed to a page where User B 502 is provided with option 557 to create the digital voucher/token.

After option 557 is selected, in a fifth step, the mobile application 552 is directed to a page where User B 502 is required to enter unique identifiers of User C 504 (i.e. beneficiary), such as name and mobile number of User C 404. Along with a value that User B 502 is willing to offer, there is an optional unique identifier field for an Identification (ID) number of User C 504. The ID number may be a regular ID number, e.g. a passport number. Alternatively, the ID number may be associated with biometric data of User C 504. For example, the ID number may be an Aadhaar number of User C 504.

Additionally in the fifth step, User B 502 may be able to indicate an expiry date for the digital voucher/token, which will allow User C 504 to use the digital voucher/token (which will be generated in the next step) for that period of time. After all the User C 504 details are entered in the fifth step, option 559 can be selected to request for generating a unique code of the digital voucher. The unique code of the digital voucher can be interchangeably referred to as a beneficiary sub-token number in the present embodiment.

In a sixth step, a request (not shown) is sent to the payment network server 556 to generate the unique code of the digital voucher. The unique code of the digital voucher identifies the issuer party of the funding account and the payment network, and is associated with the unique identifier (e.g. the phone number) of User C 504. it is appreciable to the skilled person in the art that prior to the sixth step, the payment network server 556 may have checked its database to verify whether the funding account has a sufficient balance that is not less than the value of the digital voucher indicated in the request, e.g. 2000 INR. In addition, the payment network server 556 may generate an OTP for verification of User C's 504 phone number.

In a seventh step, prior to or in the meanwhile as the payment network server 556 generates the unique code of the digital voucher, the payment network server 556 may also record the digital voucher into a database therein. Since the request for generating the unique code was originally raised by User B 502, the unique identifiers of User B 504 are associated with the unique code of the digital voucher and recorded into a profile 561 of the funding account of User B 502 (e.g. the other digital voucher of User B 502 in the present embodiment). Advantageously, the profiles of different generations of digital vouchers can be interlinked, such that the initial source of funding account of a digital voucher can be tracked. An example of the profile 561 of the funding account of User B 502 is shown in FIG. 5B, the content of which is self-explanatory.

In an eighth step, the payment network server 556 generates the unique code of the digital voucher. As described above, the unique code can be a sixteen-digit string generated by the payment network server 556 based on a card number of User B 502. A portion of this unique code is fixed as it is needed to identify the payment network in which the digital voucher can be used and the issuer party of the funding account. For example, FIG. 5B shows an exemplified unique code “543333-XXXXXXXXXX”, the first six digits of the unique code indicate an Issuer Identification number and the very first digit indicates the payment network, while the remainder is randomly generated.

In a ninth step, the generated unique code of the digital voucher may be distributed to User C 504 based on the phone number of User C 504.

FIG. 6 shows an embodiment of a profile of a digital voucher 604.

In the profile, based on a funding account 602 of User A having a payment card number of 543210-XXXXXXX-1234, the digital voucher 604 having a value of 5000 INR is generated for User B. The digital voucher 604 is generated with a unique code of 543333-XXXXXXX-2233. Based on the digital voucher 604 of User B, a further digital voucher 606 having a value of 2000 INR can be further generated with a unique code of 543333-XXXXXXX-2325.

In the profile, the funding account 602, the digital voucher 604 and the funding account 604 are interlinked. Advantageously in this manner, the initial source of funding account of a digital voucher can be tracked. The profile can be stored in a database of a payment network server or an issuer server.

FIG. 7 shows an illustration of information flow in an embodiment of a system 700 for creating and processing a digital voucher for a beneficiary (interchangeably referred to as “User” in FIG. 7), in which the steps as depicted in FIG. 2 can be implemented.

In the present embodiment, the system 700 comprises a User 702 of a digital voucher (not shown in FIG. 7) and a participating party 710 where the digital voucher can be used for remittance of a transaction. In this embodiment, the User 702 can be User B as described above with regard to FIGS. 4A and 4B, whose digital voucher is created based on a funding account of User A. The digital voucher is referred to as “token”, and the unique code of the digital voucher is referred to as “token number” in FIG. 7. The system 700 further comprises an acquirer server 704, a payment network server 706 and an issuer server 708.

In the present embodiment, the digital voucher may have a value of 5000 INR. The participating party 710 can be an ATM 710 of an acquirer, a POS terminal 710 of a merchant, a payment application 710 embedded on an e-commerce website or a software application of a merchant. The ATM 710, the POS terminal 710 or the payment application 710 can be administered by a stand-alone payment server 710 that communicates with the acquirer server 704. Alternatively, the ATM 710, the POS terminal 710 or the payment application 710 are administered by the acquirer server 704. In the present embodiment, the transaction may include a cash withdrawal transaction at the ATM 710, or a payment transaction at the POS terminal 710 or the payment application 710.

In the present embodiment, User 702 decides to use the digital voucher to withdraw cash at the ATM 710, or remit the payment transaction at the POS terminal 710 or the payment application 710. The amount of the required cash or the total of the payment transaction may be less than 5000 INR, such as 3000 INR.

In step 712, User 702 enters a unique code of the digital voucher to the ATM 710, the POS terminal 710 or the payment application 710 with a request (not shown in FIG. 7) to withdraw cash or remit the payment transaction at an amount of 3000 INR using the digital voucher.

As described above, as the very first digit of the unique code indicates the payment network and the first six digits of the unique code indicate an Issuer Identification number, the ATM 710, the POS terminal 710 or the payment application 710 routes the request to the respective acquirer server 704 based on the unique code in step 714.

In step 716, depending on the very first digit indicating the payment network and the first six digits indicating the Issuer Identification number, the acquirer server 704 routes the request and the unique code of the digital voucher to a corresponding payment network server 706.

In step 718, the payment network server 706 validates the digital voucher by verifying the value and expiry date of the digital voucher stored in a database of the payment network server 706.

As described above, the unique code of the digital voucher is associated with a unique identifier of User 702. For example, the unique identifier is a phone number or an identification number that is associated with biometric data of User 702 that is stored in a database of the payment network server 706.

In step 720, once the digital voucher is validated, the payment network server 706 generates an one time password (OTP) and sends it to User 702 based on the phone number.

In step 722, User 702 enters the OTP to the ATM 710, the POS terminal 710 or the payment application 710.

In step 724, the ATM 710, the POS terminal 710 or the payment application 710 Recipient forwards the OTP to the payment network server 706 via the acquirer server 704.

Once the OTP is verified successfully, the payment network server 706 authorizes the cash withdrawal or the payment transaction and obtains the funding account of the digital voucher that is linked to unique code of the digital voucher from the database in step 726.

In step 728, the payment network server 706 sends the funding account to the issuer server 708, which verifies the funding account in step 730. In addition to the funding account, the payment network server 706 also sends a request to the issuer server 708 to deduct the amount of the transaction from the funding account of User A.

In step 732, the issuer server 708 approves or declines the the cash withdrawal or the payment transaction based on a comparison of the amount of the transaction with an amount blocked in the funding account in the issuer server 708 corresponding to the value of the digital voucher at the time of the digital voucher creation process.

If approved, the required cash is dispatched from the ATM 710 and/or the payment transaction is paid in step 734. The remainder of the digital voucher is updated at the database of the payment network server 706 and/or the issuer server 708. Additionally or optionally, a new digital voucher can be generated for the remainder of the digital voucher.

FIG. 8 shows an exemplary computing device 800 to realize a server for creating a digital voucher or a server for processing a digital voucher credit in accordance with the embodiments shown in FIGS. 1 to 7. The server for creating a digital voucher and the server for processing a digital voucher can be the same server (for example, a server that administers a payment network/payment network server) according to various embodiments. In addition, the exemplary computing device 800 can also be implemented to realize a payment server that administers the ATM 710, the POS terminal 710 or the payment application 710 and communicates with the acquirer server 704 for payment of transactions.

As shown in FIG. 8, the example computing device 800 includes a processor 804 for executing software routines. Although a single processor is shown for the sake of clarity, the computing device 800 may also include a multi-processor system. The processor 804 is connected to a communication infrastructure 806 for communication with other components of the computing device 800. The communication infrastructure 806 may include, for example, a communications bus, cross-bar, or network.

The computing device 800 further includes a main memory 808, such as a random access memory (RAM), and a secondary memory 810. The secondary memory 810 may include, for example, a storage drive 812, which may be a hard disk drive, a solid state drive or a hybrid drive and/or a removable storage drive 814, which may include a magnetic tape drive, an optical disk drive, a solid state storage drive (such as a USB flash drive, a flash memory device, a solid state drive or a memory card), or the like. The removable storage drive 814 reads from and/or writes to a removable storage medium 844 in a well-known manner. The removable storage medium 844 may include magnetic tape, optical disk, non-volatile memory storage medium, or the like, which is read by and written to by removable storage drive 814. As will be appreciated by persons skilled in the relevant art(s), the removable storage medium 844 includes a non-transitory or transitory computer readable storage medium having stored therein computer executable program code instructions and/or data.

In an alternative implementation, the secondary memory 810 may additionally or alternatively include other similar means for allowing computer programs or other instructions to be loaded into the computing device 800. Such means can include, for example, a removable storage unit 822 and an interface 530. Examples of a removable storage unit 822 and interface 830 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 822 and interfaces 830 which allow software and data to be transferred from the removable storage unit 822 to the computer system 800.

The computing device 800 also includes at least one communication interface 524. The communication interface 824 allows software and data to be transferred between computing device 800 and external devices via a communication path 826. In various embodiments of the inventions, the communication interface 824 permits data to be transferred between the computing device 800 and a data communication network, such as a public data or private data communication network. The communication interface 824 may be used to exchange data between different computing devices 800 which such computing devices 800 form part of an interconnected computer network. Examples of a communication interface 824 can include a modem, a network interface (such as an Ethernet card), a communication port (such as a serial, parallel, printer, GPIB, IEEE 1394, RJ45, USB), an antenna with associated circuitry and the like. The communication interface 824 may be wired or may be wireless. Software and data transferred via the communication interface 824 are in the form of signals which can be electronic, electromagnetic, optical or other signals capable of being received by communication interface 824. These signals are provided to the communication interface via the communication path 826.

As shown in FIG. 8, the computing device 800 further includes a display interface 802 which performs operations for rendering images to an associated display 830 and an audio interface 832 for performing operations for playing audio content via associated speaker(s) 834.

As used herein, the term “computer program product” may refer, in part, to removable storage medium 844, removable storage unit 822, a hard disk installed in storage drive 812, or a carrier wave carrying software over communication path 826 (wireless link or cable) to communication interface 824. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 800 include radio or infra-red transmission channels as well as a network connection to another computer or networked device, and the Internet or Intranets including e-mail transmissions and information recorded on Websites and the like.

The computer programs (also called computer program code) are stored in main memory 808 and/or secondary memory 810. Computer programs can also be received via the communication interface 824. Such computer programs, when executed, enable the computing device 800 to perform one or more features of embodiments discussed herein. In various embodiments, the computer programs, when executed, enable the processor 804 to perform features of the above-described embodiments. Accordingly, such computer programs represent controllers of the computer system 800.

Software may be stored in a computer program product and loaded into the computing device 800 using the removable storage drive 814, the storage drive 812, or the interface 850. Alternatively, the computer program product may be downloaded to the computer system 800 over the communications path 826. The software, when executed by the processor 804, causes the computing device 800 to perform functions of embodiments described herein.

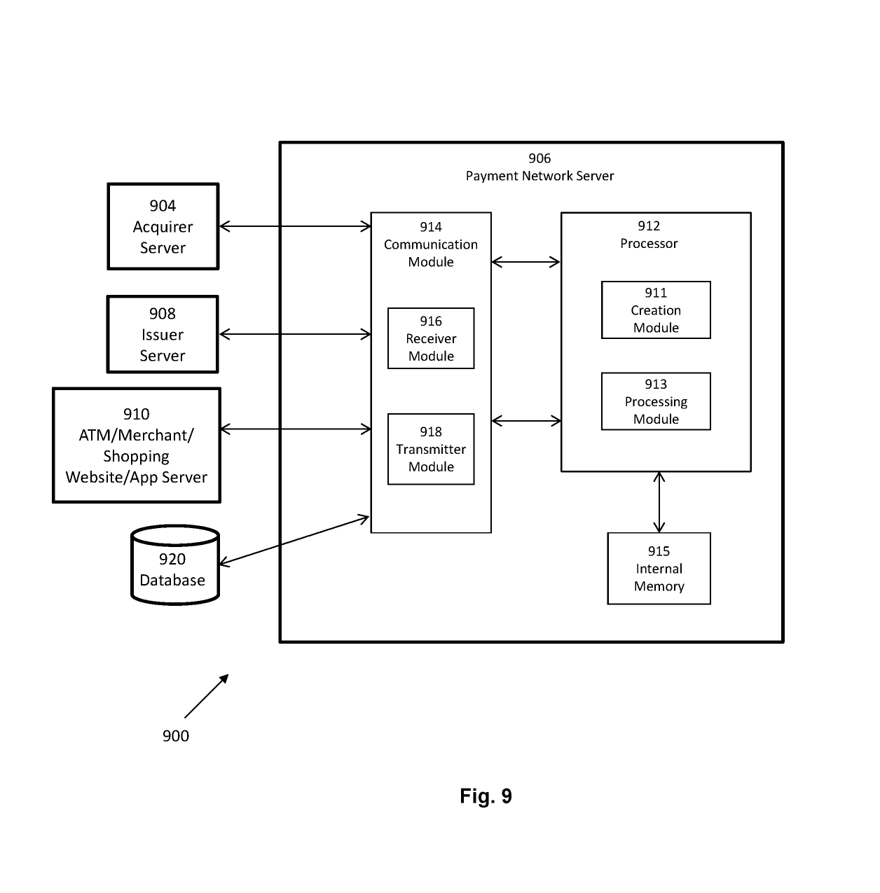

FIG. 9 shows a schematic diagram of modules in a payment network server 906 (such as the payment network server 406, 456, 506, 556, 706 depicted in FIGS. 4A, 4B, 5A, 5B and 7) suitable for use in the systems as depicted in FIGS. 4A, 4B, 5A, 5B and 7 for creating and/or processing a digital voucher according to various embodiments.

As shown in FIG. 9, the payment network server 906 includes a processor 912, an internal memory 915 and a communication module 914. Data may be transferred between the processor 912 and internal memory 915 through a data connection such as, for example, a data bus. Likewise, data may be transferred between the processor 912 and the communication module 914 through a data connection such as, for example, a data bus. The processor 912 further includes a creation module 911 and a processing module 913. In an embodiment, the creation module 911 and processing module 913 may be separate from the processor 912, such that communication and data transfer between the processor 912, creation module 911 and processing module 913 may be through data bus connection between the modules. The communication module 914 further includes a receiver module 916 and a transmitter module 918. The receiver module 916 and transmitter 918 may be implemented as a single transceiver unit.

In an embodiment when the payment network server 906 is configured to create a digital voucher, the receiving module 512 receives data from an issuer server 908 or a server 910 that administers a website or a mobile application of the payment network. The received data may include: data of a funding account of the first user as described above, a request for utilising the funding account to create a digital voucher having a value for the second user, data of the second user as described above such as the unique identifier of the second user.

The above data may be received via a wired or wireless internet connection. The received data is sent, for example via a data bus connection between the receiver module 916 and the processor 912, from the receiver module 916 to the processor 912.

Based on the received data, the creation module 911 of the processor 912 generates a unique code of the digital voucher upon verification of a sufficient balance in the funding account with the issuer server 908. The unique code identifies the issuer party of the funding account and the provider of the payment network, and is associated with the unique identifier of the second user. The unique code of the digital voucher for the second user may be recorded/stored into a profile of the funding account in a database 920 or the internal memory 915 of the payment network server 906.

The transmitter module 918 transmits the generated unique code of the digital voucher to the issuer server 908 and/or the server 910 that administers a website or a mobile application of the payment network, which may forward the unique code of the digital voucher to the second user based on his/her unique identifier. Alternatively, the transmitter module 918 may directly transmit the generated unique code of the digital voucher to the second user based on his/her unique identifier.

In consequence, the issuer server 908 may deduct or block the value of the digital voucher in the funding account of the first user, and record/store the unique code of the digital voucher for the second user in a profile of the funding account of the first user in its database, if any.

In another embodiment when the payment network server 906 is configured to process a digital voucher, the receiving module 512 receives data from an acquirer server 904 or a payment server 910 that administers an ATM, a POS terminal or a payment application and communicates with the acquirer server 904 for payment of transactions. The received data may include: data of the digital voucher (e.g. the unique code of the digital voucher that identifies the payment network and the issuer party of the funding account based on which the digital voucher is created, etc), a request for processing the digital voucher for remitting a transaction for the second user at a participating party that communicates with the payment network server 904, data of the transaction (including payment amount of the transaction, products purchased in the transaction, the acquirer party of the participating party, etc), data of the second user (e.g. the unique identifier of the second user, etc).

The above data may be received via a wired or wireless internet connection. The received data is sent, for example via a data bus connection between the receiver module 916 and the processor 912, from the receiver module 916 to the processor 912.

Based on the received data, the processing module 913 of the processor 912 validates the digital voucher upon verification of the received unique code of the digital currency based on the unique identifier of the second user. As shown in FIG. 7, the processing module 913 may verify whether the received unique code can be found in the database 900 or the internal memory 915. If the received unique code can be found in a profile of a funding account recorded in the database 900 or the internal memory 915, the processing module 913 may generate an One Time Password (OTP) and send it to the second user based on the unique identifier of the second user. If the processing module 913 then receives the same OTP from the second user (not shown in FIG. 9), or from the acquirer server 904 or the payment server 910 that relays the OTP from the second user, the second user is then authenticated and the remittance of the transaction is thereby authorised by the processing module 913 using at least a portion of the value of the digital voucher. It is assumed in this embodiment that the amount of the transaction is not more than the value of the digital voucher. Since the unique code identifies the issuer party of the funding account and the provider of the payment network, the processing module 913 then communicates with the transmitter module 918 to send a request to the issuer server 908 to pay the amount of the transaction, which is at least a portion of the value of the digital voucher, using the deducted or blocked value in the issuer server 908.

In consequence, the issuer server 908 may deduct the amount of the transaction value, which is at least a portion of the value of the digital voucher, from the deducted or blocked value of the funding account, and update the remainder of the digital voucher for the second user in the profile of the funding account of the first user in its database, if any. Additionally or optionally, a new digital voucher can be generated for the remainder of the digital voucher in accordance with the embodiment of creating a digital voucher as described above.

Additionally or alternatively, the processing module 913 may also update the remainder of the digital voucher for the second user in the profile of the funding account of the first user in the database 920 or the internal memory 915 of the payment network server 906.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects illustrative and not restrictive.

1. A method for utilising a funding account of a first user to create a digital voucher having a value for a second user, the digital voucher being usable by the second user for remitting one or more transactions across participating parties that communicate with a payment network, the method comprising:
generating, at a server for creating the digital voucher, a unique code of the digital voucher upon verification of a sufficient balance in the funding account, the unique code identifying an issuer party of the funding account and a payment network provider of the payment network,
wherein the unique code is associated with a unique identifier of the second user.

2. The method according to claim 1, wherein the unique identifier comprises a phone number of the second user.

3. The method according to claim 1, wherein the unique identifier comprises an identification number that is associated with biometric data of the second user.

4. The method according to claim 1, further comprising:
recording the digital voucher into a profile of the funding account at a database of the server that administers the payment network.

5. The method according to claim 1, wherein the step of generating the unique code is activated by the server for creating the digital voucher in response to receipt of a request from a server administered by the issuer party for creating the digital voucher having the value.

6. The method according to claim 1, wherein the step of generating the unique code is activated by the server for creating the digital voucher in response to receipt of a request from a server that administers a website or a mobile application of the payment network for creating the digital voucher having the value.

7. The method according to claim 5, wherein the server for creating the digital voucher comprises a server administered by the payment network.

8. The method according to claim 5, wherein the server for creating the digital voucher comprises the server administered by the issuer party.

9. The method according to claim 5, further comprising:
upon generation of the unique code, deducting the value from the funding account at the server administered by the issuer party.

10. The method according to claim 5, further comprising:
upon generation of the unique code, blocking the value from the funding account at the server administered by the issuer party,
wherein the blocked value will be partially or fully deducted from the funding account by the server that administers the issuer party at the time of remitting the one or more transactions for the second user using the digital voucher.

11. The method according to claim 5, further comprising:
distributing, by the server that administers the payment network, the unique code to the second user based on the unique identifier.

12. The method according to claim 5, further comprising:
providing the unique code from the server that administers the payment network to the server that administers the issuer party; and
distributing, by the server that administers the issuer party, the unique code to the second user based on the unique identifier.

13. The method according to claim 1, wherein the funding account is a payment card account issued by the issuer party.

14. The method according to claim 1, wherein the funding account is another digital voucher created by the server that administers the payment network based on another funding account issued by the issuer party.

15. The method according to claim 14, further comprising:
recording the digital voucher into a profile of the other funding account at the server that administers the payment network.

16. The method according to claims 1, wherein the one or more transactions across participating parties that communicate with the payment network comprise:
a cash withdrawal transaction at an ATM machine administered by a server of an acquirer party in the payment network.

18. The method according to claim 1, wherein the one or more transactions across participating parties that communicate with the payment network comprise:
a payment transaction at an acquirer party in the payment network.

18. A server that administers a payment network for utilising a funding account of a first user to create a digital voucher for a second user having a value, the digital voucher being usable by the second user for remitting one or more transactions across participating parties that communicate with a payment network, the server comprising:
at least one processor; and
at least one memory including computer program code;
the at least one memory and the computer program code configured to, with the at least one processor, cause the server at least to:
generate a unique code of the digital voucher upon verification of a sufficient balance in the funding account, the unique code identifying an issuer party of the funding account and a payment network provider of the payment network,
wherein the unique code is associated with a unique identifier of the second user.

19. The server according to claim 18, wherein the server is further caused to:
record the digital voucher into a profile of the funding account at the server that administers the payment network.

20. The server according to claim 18, wherein the server is further caused to:
generate the unique code in response to receipt of a request from a server that administers the issuer party for creating the digital voucher having the value.
